(19) United States
(12) Patent Application Publication
(10) Pub. No.: US 2025/0315746 A1
(43) Pub. Date: Oct. 9, 2025

(54) AUTOMATED AGENT COACHING

(71) Applicant: Verint Americas Inc., Alpharetta, GA (US)

(72) Inventors: Ian BEAVER, Chino Valley, AZ (US); Cynthia FREEMAN, Green Valley, AZ (US); Jose BENKI, Ann Arbor, MI (US)

(21) Appl. No.: 18/626,831

(22) Filed: Apr. 4, 2024

(51) Int. Cl. G06Q 10/0631; G06Q 10/0639

(52) U.S. Cl. CPC G06Q 10/06311; G06Q 10/0639

(57) ABSTRACT

A method for providing automated agent performance improvement includes obtaining a ranking for each agent of a plurality of agents; obtaining customer-agent interactions for each agent; determining a task label for each of the customer-agent interactions; selecting a first set of customer-agent interactions from the customer-agent interactions corresponding to a first task label; receiving application event streams corresponding to the first set of customer-agent interactions and comprising agent application usage data; analyzing the application event streams for statistically relevant differences for one or more activities performed by a first group of agents compared to a second group of agents; determining at least one activity of the one or more activities that is performed by the first group of agents differently than the second group of agents; generating guidance corresponding to the least one activity for the second group of agents; and deploying the guidance to the second group of agents.

### INTRODUCTION

### Technical Field

The present disclosure relates to techniques for automating agent coaching.

### Background

Customer support services are an obligatory aspect of providing customers services or goods. Customer support services provide a means for a consumer of a service or a good to correspond with a company providing the service or good. Consumers contact customer support services for a wide range of reasons. For example, consumers contact customer support service to make a change to the service, address an issue with the service or good, provide feedback to a company, seek information about a service or good, and many other reasons.

Customer support services typically consist of human operated contact centers that correspond with customers via voice call, video call, email, or chat. In addition to recording a conversational interaction (also referred to as a session) between a representative of the customer support service and the consumer, other metrics may be manually recorded by the representative, such as summarizing the interaction. For example, the representative, post-conversational interaction, may write up a brief summary of the interaction and submit it with the record of the interaction.

Companies providing services and goods and customer support service operators are increasingly interested in improving customer-agent interactions. To improve customer-agent interactions, companies currently rely on surveys generated by customers following the customer-agent interaction. The surveys can inform supervisors as to customer-based KPI metrics and performance of agents.

### SUMMARY

One aspect provides a method for providing automated agent coaching, comprising: obtaining a ranking for each agent of a plurality of agents; obtaining a plurality of customer-agent interactions for each agent of the plurality of agents; determining a task label for each of the plurality of customer-agent interactions; selecting a first set of customer-agent interactions from the plurality of customer-agent interactions corresponding to a first task label; receiving application event streams corresponding to the first set of customer-agent interactions and comprising agent application usage data obtained during a customer-agent interaction; analyzing the application event streams for statistically relevant differences for one or more activities performed by a first group of agents of the plurality of agents compared to a second group of agents of the plurality of agents, where the first group of agents is identified as higher performing agents compared to the second group of agents based on the ranking for each agent of the plurality of agents; determining at least one activity of the one or more activities that is performed by the first group of agents differently than the second group of agents; generating guidance corresponding to the least one activity for the second group of agents; and deploying the guidance to the second group of agents.

Another aspect provides, an apparatus configured for providing automated agent performance ranking, comprising: one or more memories comprising processor-executable instructions; and one or more processors configured to execute the processor-executable instructions and cause the apparatus to: obtain a ranking for each agent of a plurality of agents; obtain a plurality of customer-agent interactions for each agent of the plurality of agents; determine a task label for each of the plurality of customer-agent interactions; select a first set of customer-agent interactions from the plurality of customer-agent interactions corresponding to a first task label; receive application event streams corresponding to the first set of customer-agent interactions and comprising agent application usage data obtained during a customer-agent interaction; analyze the application event streams for statistically relevant differences for one or more activities performed by a first group of agents of the plurality of agents compared to a second group of agents of the plurality of agents, where the first group of agents is identified as higher performing agents compared to the second group of agents based on the ranking of each agent of the plurality of agents; determine at least one activity of the one or more activities that is performed by the first group of agents differently than the second group of agents; generate guidance corresponding to the least one activity for the second group; and deploy the guidance to the second group of agents.

One aspect provides a method for providing automated agent coaching, comprising: obtaining a ranking for each agent of a plurality of agents obtaining a plurality of customer-agent interactions and features associated with each of the plurality of customer-agent interactions; analyzing, per feature, the plurality of customer-agent interactions for statistically relevant differences in behavior by a first group of agents of the plurality of agents compared to a second group of agents of the plurality of agents, wherein the first group of agents is identified as higher performing agents compared to the second group of agents based on the ranking for each of the plurality of agents; determining at least one feature of the features where the behavior of the first group of agents corresponding to the at least one feature is different than the second group of agents; generating guidance corresponding to the least one feature for the second group of agents; and deploying the guidance to the second group of agents.

These and additional features provided by the aspects described herein will be more fully understood in view of the following detailed description, in conjunction with the drawings.

### DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 schematically depicts an illustrative block diagram of a key performance indicator (KPI) prediction process.

FIG. 2 schematically depicts an illustrative block diagram of a KPI improvement process.

FIG. 3 schematically depicts an illustrative block diagram of an automated agent performance ranking process.

FIG. 4 continues to depict the illustrative block diagram of the automated agent performance ranking process depicted in FIG. 3.

FIG. 5 schematically depicts an illustrative block diagram of an automated agent coaching process.

FIG. 6 continues to depict the illustrative block diagram of the automated agent coaching process depicted in FIG. 5.

FIG. 7 schematically depicts an illustrative block diagram for further aspect of the automated agent coaching process depicted in FIGS. 5 and 6.

FIG. 8 depicts an illustrative flowchart for an example method for providing automated agent coaching.

FIG. 9 depicts an illustrative flowchart for further aspects of an example method for providing automated agent coaching.

FIG. 10 schematically depicts an example apparatus for implementing the automated agent coaching.

### DETAILED DESCRIPTION

Embodiments of the present disclosure are directed to techniques for automated agent coaching. In aspects, the automated agent performance rankings utilize a key performance indicator prediction process to generate performance data otherwise unavailable. Performance data for determining an agent's performance may be scare and nonspecific because post interaction surveys only provide sparse information and lack dense (e.g., detailed and numerous) insights for use in evaluating the agent's performance. The automated agent performance ranking processes described herein provide techniques for analyzing historical interaction data and near real-time customer-agent interactions to develop agent performance scores based on features of a customer-agent interaction, the type or difficulty of task being performed, and generating reports regarding the performance. As used herein, the term “near real-time” refers to events occurring at a current time and a margin for processing time to provide generate a response to an input such that the response can be utilized during the occurrence of the event. The reports include quantifiable performance information that a supervisor and/or automated coaching system can use to generate responsive actions, such as training modules or positive reinforcement for an agent. It should be understood that the term “agent” as discussed herein refers to either human agents or computer-driven bots, such as chatbots, unless specifically stated otherwise.

The techniques for described herein may be utilized on a variety of conversational interactions. For example, conversational interactions may arise from any type of interaction between two or more entities. The types customer-agent of interactions may include human-to-human interactions, human-to-chatbot interactions, or even chatbot-to-chatbot interactions. As used herein, chatbot refers to artificial intelligence-based engines configured to simulate human conversation through text, video, and/or voice. Chatbots may also be referred to herein as intelligent virtual agents (IVA). IVAs are chatbots that can engage with a human customer or another chatbot using understandable human speech. IVAs may be trained and refined based on interactions, but do not need to be specifically programmed to handle certain types of interactions. Instead, IVAs implement a combination of natural language processing (NLP), natural language understanding (NLU), machine learning, and generative and conversational artificial intelligence (AI) to recognize human speech, understand the intent behind it, and respond in a way that mimics human conversation. Through interactions, IVAs can increase their vocabulary, learn nuances of speech, such as the use of slang terms or acronyms, and adapt based on feedback from other entities they are interacting with and through directed training operations, such as supervised learning. The means in which the interactions may occur include, but are not limited to voice calls, video calls, emails, instant messages, and chats.

Mechanisms for recording conversational interactions exist. For example, a video or voice call may be recorded into a media file. In near real-time or at a later time, the media file can be transcribed into a text-based file converting at least audio aspects of the media into readable text. Text based conversational interactions can be recorded and stored as a text-based data file.

Companies offering services or goods to consumers or customer support services desire to utilize the recorded content from conversational interactions for a variety of purposes. For example, evaluation of the customer-agent interactions can provide insights regarding a customer's satisfaction or dissatisfaction through methods and apparatuses described herein. Currently, KPIs such as a customer satisfaction score are only obtainable through post interaction surveys, which historically have a low compliance rates and are generally limited in scope.

Since post interaction surveys are sparse and lack dense (e.g., detailed and numerous) insights for use in evaluating key performance metrics, the present disclosure provides systems, methods, and apparatuses for predicting KPIs from customer-agent interactions. As discussed in more detail herein, the KPI prediction and improvement processes enable the prediction of a value for a KPI metric, irrespective of the presence of a post interaction survey, and can further provide suggested agent-controllable features of a customer-agent interaction that can be improved to maintain or improve a KPI metric. The solutions provided in the present disclosure reduce or eliminate the need for post interaction surveys by providing technical solutions to identifying and measuring features present in customer-agent interactions to predict a KPI metric. KPI metrics include, but are not limited to, customer satisfaction scores (CSAT), customer churn rate (Churn), net promoter score (NPS), and the like. CSAT is a metric that indicates how satisfied customers are with a company's products or services. Churn is the percentage of customers who stop doing business with an organization over a period of time. NPS is a metric that quantifies customer loyalty by looking at their likelihood of recommending a given business.

Example features of a customer-agent interaction during a call, for example, include past average CSAT, Churn, NPS of an agent over a past period of time, the time an agent spends talking during the call with a customer, the time a customer spends talking during the call, the number of interruptions by the agent of the customer in the call, number of interruptions by the customer of the agent, time between an agent's hire date and the call date, call duration, number of holds in the call, the time of mutual silence in the call, number of words spoken by the agent, number of words spoken by the customer, agent speaking rate in word per minute, customer speaking rate in words per minute, number and duration of agent pauses, number and duration of customer pauses, number of conversational turns, the screen module used in the call, knowledge management (KM) searches conducted by the agent, customer relationship management (CRM) access patterns by the agent, survey variables and/or any other features that can be extracted from the customer-agent interaction.

A company, such as a contact center operator, may desire to maintain or improve one or more KPI metrics, but without a statistically significant number of post interaction surveys, the company is unable to effectively determine a value for the one or more KPI metrics and more significantly understand the features of the contact center operation, such as features of the customer-agent interaction that drive the KPI metric. The present disclosure provides solutions to this problem which include training classifier models, such as a gradient boosting classifier, random forest classifier, or other machine learning-based classifiers to analyze features of a customer-agent interaction and predict a value for the desired KPI metric.

The technical solutions described herein utilize data from multiple sources, for example, speech analytics (SA), KM, CRM, and the like along with defined features of a customer-agent interaction to train a classifier model to predict a KPI metric. The technical solutions further provide a process for identifying features of the customer-agent interaction that have a potential for improvement and providing a recommendation as to which features and the amount each of the features need to be improved to meet a target value for the KPI metric. That is, the technical solutions not only provide a prediction of KPI, but also give insight to the user on how they can improve specific, targeted areas of their contact center to meet their KPI goals.

The technical solutions for predicting a KPI metric from customer-agent interaction data provide the technical benefit of reducing or eliminating reliance on post interaction surveys and analysis thereof and improving how a company, such as a contact center operator, can maintain and improve KPI metrics that are relevant to their business.

Additionally, companies, such as a contact center operator, need to not only know whether current operations are meeting their KPI goals or not, but also what features and agents can be improved and trained in order to improve and maintain KPI goals. In view of the technical solutions that address the problem of scarcity and nonspecific performance data, additional technical solutions associated with providing automated agent performance ranking provide the technical benefit of automated processes for analysis and reporting of performance data into a digestible and actionable form. As described in more detail herein, the technical solutions provide techniques that dissect and analyze performance on an equal basis to derive reports that identify changes in performance of an agent, gaps in knowledge or skills of an agent, as well as ranking agents in groups based on specific tasks and skills (e.g., performance with respect to features that drive KPI metrics). The automated agent performance ranking processes can directly report on the agents change in performance over time for each feature impacting KPIs without the need to create review questions and evaluation rules. The automated agent performance ranking processes can also directly report on the highest and lowest performing agents on features under the agents control that have a direct statistical link to the client chosen KPI metrics.

For each feature under agents' control, the agents are ranked by historical performance. The rankings are reported to agent coaching applications, for example, in a highest to lowest agent rank based on historical performance.

Each agent's performance for each feature on the latest interaction is compared to their own historical performance by applying an outlier detection process. If there is a significant drop in performance over any feature as determined by a threshold, an indication (e.g., an alert or report) is made to the agent coaching applications. The outlier detection process may further be configured to detect a decrease in performance over time.

Agent coaching is currently facilitated by supervisors analyzing reports on performance and attempting to identify training modules that would improve an agent's performance. That is, agent coaching requires significant time for a supervisor to compile and digest post interaction survey information, review customer-agent interaction transcripts, make determinations as to what improvements can be made and further developing and providing coaching materials to the agent. Additionally, in some instances supervisors may identify several areas of improvement for an agent, but do not have the means or a process to determine which area of improvement would be most beneficial to address to improve the KPI for the contact center. Furthermore, current coaching processes are not able to be implemented in near real-time while an agent is engaged in an interaction such that they can be actively coached. Present training processes may be overly generalized or miss the mark with respect to the specific training an agent needs. For example, training may be required for handling specific types of tasks as opposed to altering behaviors correlated to features of an interaction. In other words, an agent may not lack skills with respect to conversing with a customer. Instead, poor performance may manifest itself as a skills gap, such as not effectively managing long periods of silence, when an agent is not well trained on handling specific types of tasks, such as answering billing questions as opposed to assisting with a password reset. Therefore, there is a need to be able to distinguish between an agent's skill set and an agent's ability to handle specific types of interaction tasks.

The automated agent coaching processes described herein provide technical solutions for automatically analyzing interaction history, performance and task-specific activities between groups of relatively higher and relatively lower performing agents. The analysis provides insights into what types of activities or behaviors, with respect to features of a customer-agent interaction, should be addressed, for example, by comparing what high-performing agents do compared to low-performing agents. In some aspects, statistical analysis of values such as performance scores on features and corresponding tasks are determined for high and low-performing agents or groups of agents to determine whether there are statically relevant differences. The statically relevant differences can provide indication as to what activity, features, and task related to the activity or feature differ and thus require coaching. Coaching modules may be predefined by supervisors and selected for deployment when an agent's performance corresponding to the activity, feature, or task is indicated as requiring improvement.

Automatic and tailored coaching provides a technical benefit of providing efficient and effective training that directly relates to improvement potential for the agent and furthermore increasing and/or maintaining a target value for a KPI metric.

### Aspects Related to Predicting a KPI Metric

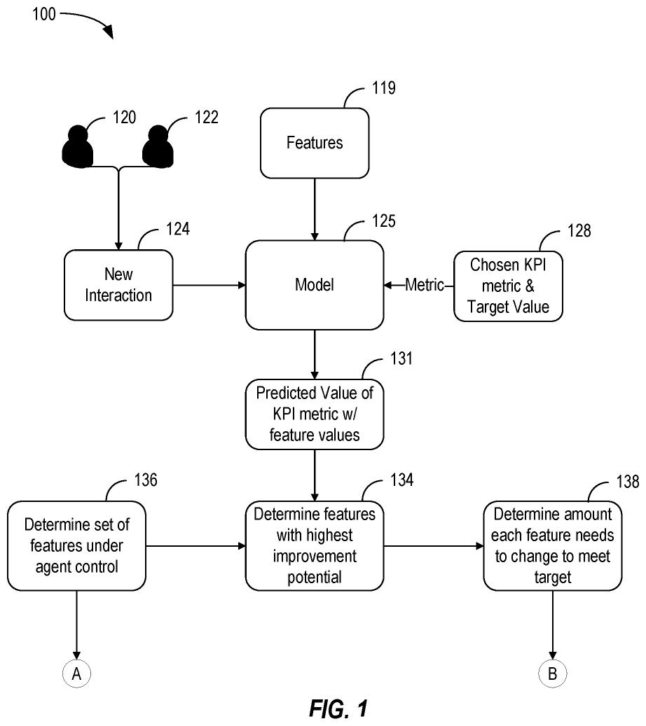

FIG. 1 depicts an illustrative block diagram 100 of a KPI prediction process for predicting a client chosen KPI metric is depicted. A customer 120 corresponds with an agent 122 through email, voice, text, chat or the like which are compiled as customer-agent interaction data. The KPI prediction process predicts a value for the KPI metric and provides an indication of one or more features that can maintain and/or improve the value of the KPI metric when the one or more features are improved. The KPI prediction process includes invoking a model 125 configured predict the value for the KPI metric based on a plurality of features that the classifier model identifies and measures from the customer-agent interaction data. More specifically, the model 125 is configured to ingest customer-agent interaction data 124, a feature set 119, and the KPI metric and target value for the KPI metric 128.

Based on the KPI metric selected by the client, the corresponding model 125 is either created, if one does not already exist, or is selected from a plurality of models. The selected model 125 generates a predicted value for the KPI metric specified by the client. The selected model 125 may be a classifier model or another type of machine learning model configured to perform as described herein. The model 125 predicts a value for the KPI metric based on a plurality of features that the classifier model 125 identifies and measures from the customer-agent interaction data. Additionally, the model 125 generates a score for each feature associated with the KPI metric. Each feature score corresponds to an agent's performance with respect to the feature during the customer-agent interaction. The model 125 then outputs the predicted value 131 for further utilization by the system executing the KPI prediction process or by another system or application, such as an agent coaching application or a performance ranking application.

At step 134, features with a potential for improvement are determined. Before determinations at step 134 and step 138 are carried out, step 136 provides one or more sets of predefined features that are determined to be controllable by an agent, such as a human agent, a chatbot, or both, when engaged in a customer-agent interaction. For example, some features that are under the control of a human agent include, but are not limited to, the time an agent spends talking during a call with a customer, the number of interruptions by an agent in the call, a call duration, a number of holds in the call, the time of mutual silence in the call, the screen module used in the call, KM searches conducted by the agent, CRM access patterns by the agent, length of employment, position or title information, and the like. The aforementioned features may also apply to a chatbot. However, some of the aforementioned features would not apply to a chatbot, such as the screen module used in the call, length of employment, and position or title information. Additionally, there may be some features that apply to a chatbot that may not apply to a human agent, for example, a quantity of out-of-vocabulary inputs or a per response feedback score, such as a thumbs-up or thumbs-down, or ranking out of 5 points. While many features may apply to both human agents and chatbot, how a feature of the one or more sets of predefined features is quantified or defined may need to be refined. For example, the feature for time a human agent spent talking on call may be determined to correspond to the amount of time a chatbot spent generating a response to an input.

At step 136, the KPI prediction process may determine a type of flag to set for each of the one or more features in the set of predefined features. The type of flag may indicate whether the feature is under the control of a human agent, a chatbot, or both. In some instances, the KPI prediction process, at step 136, may indicate with a flag as to which of the features from the set of predefined features is applicable to the customer-agent interaction being analyzed based on whether the agent is a human agent or a chatbot.

Accordingly, the determinations at step 134 are based only on features that are controllable by the agent. Without limiting the determinations at step 134 and step 138 to features that are controllable by the agent, suggestions for potential improvements to increase the KPI metric may be ones that the client cannot implement as they are outside of their control, such as the time a customer spends talking during the call, time between an agent's hire date and the call date.

At step 134, for example, the system is configured to determine, from the plurality of features that the classifier model identifies and measures from the customer-agent interaction data, at least one feature with a potential for improvement such that when the at least one feature is improved, the value predicted for the KPI metric increases. Moreover, still at step 134, the in some aspects the system is configured to determine, from the plurality of features that the classifier model identifies and measures from the customer-agent interaction data, a feature with a highest improvement potential whereby improving the feature increases the value predicted for the KPI metric. For example, the model may identify the presence of features such as interruptions by the agent, mutual silence in a call, call duration, agent talk time and customer talk time within the customer-agent interaction data. The model may further quantify (e.g., measure) each of the features and determine a measured value for each which is also referred to herein as a feature value. Based on each of the measure values, the system may determine which of the features has room for improvement. This determination may take into account positively viewed feature values for the corresponding feature and compare them to the measured value to determine if there is room for improvement. For example, a positively viewed number of interruptions may be zero and a positively viewed percentage of agent talk time may be 50% or less. The difference between the measured values and the positively viewed feature values can provide an indication as to whether there is potential for improvement with respect to the feature. It is understood that this merely one example of determining whether a feature has a potential for improvement.

In similar aspects, a ranking of features may be determined. For example, the features may be ranked in a ranked list based on a margin available to improve that feature. The features may be ranked in a second ranked list based on the amount of change that an improvement to each feature would have on the KPI metric.

In similar aspects, a ranking of features may be determined. For example, the features may be ranked based on a margin available to improve that feature and the amount of change that an improvement to each feature would have on the KPI metric.

At step 138, an amount of change for each feature is determined. The amount of change indicates the amount each feature needs to change in order for the KPI metric to meet or exceed the target value. There may be multiple combinations of features and respective improvement amounts that will result in the KPI metric meeting or exceeding the target value. Accordingly, in some aspects, a matrix of features and respective amounts of change may be generated and/or output. Based on the determinations made at step 134 and step 138 a client receives actionable information which may lead to improvements in their KPI metric. For example, in some aspects, the system performing the KPI prediction process is configured to determine one or more features with a potential for improvement such that when the one or more features are improved, the value predicted for the KPI metric increases. The system may be further configured to determine an amount that each of the one or more features need to improve such that the value predicted for the KPI metric meets the target value and output a report indicating the value predicted for the KPI metric, the one or more features with the potential to improve, and the amount that each of the one or more features need to improve.

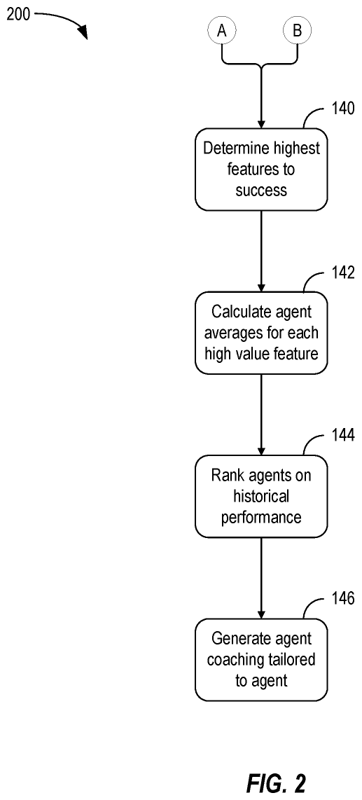

If it is determined that the value predicted for the KPI metric does not meet the target value, “No” at step 132, then the process continues to step 140, depicted and described with reference to FIG. 2.

FIG. 2 depicts an illustrative block diagram 200 that is an extension of the illustrative block diagram 100 of the KPI prediction process shown in FIG. 1. More specifically, the illustrative block diagram 200 depicts aspects of the KPI improvement process. The following process provides steps for determining which features drive the highest success in achieving or exceeding the target value for the KPI metric (step 140), calculating the agents' performance average for each feature that drives high success (step 142), ranking the agents based on historical performance (step 144), and generating tailored coaching for the agents (step 146).

Inputs to the KPI improvement process depicted in illustrative block diagram 200 include the determination as to whether the value predicted for the KPI metric meets the target value from step 132, a set of predefined features controllable by the agent from step 136, and the amount of change each feature needs to change to meet or exceed the target value for the KPI metric from step 138.

At step 140, the features that drive the highest success or positive increase in the KPI metric are determined from the features that are controllable by the agent. For example, the features are ranked from the most positive impacting feature to the least positive impacting feature.

At step 142, each agent's 122 average performance with respect to the features (e.g., the top 5%, top 10%, top 50% of the features) is calculated. In some aspects, the average performance of each agent is calculated for some or all of the features. The features the agent is evaluated on are at least the features corresponding to the set of predefined features controllable by the agent. Additionally, at step 144, the agents are ranked based on their calculated averages and/or their historical performance.

At step 146, coaching specific to improving features of an agent's interactions with a customer are generated such that training or refreshers that are relevant to the agents. Furthermore, tailored coaching provides a technical benefit of providing efficient and effective training that directly relates to improvement potential for the agent.

### Aspects Related to Automating Agent Performance Ranking

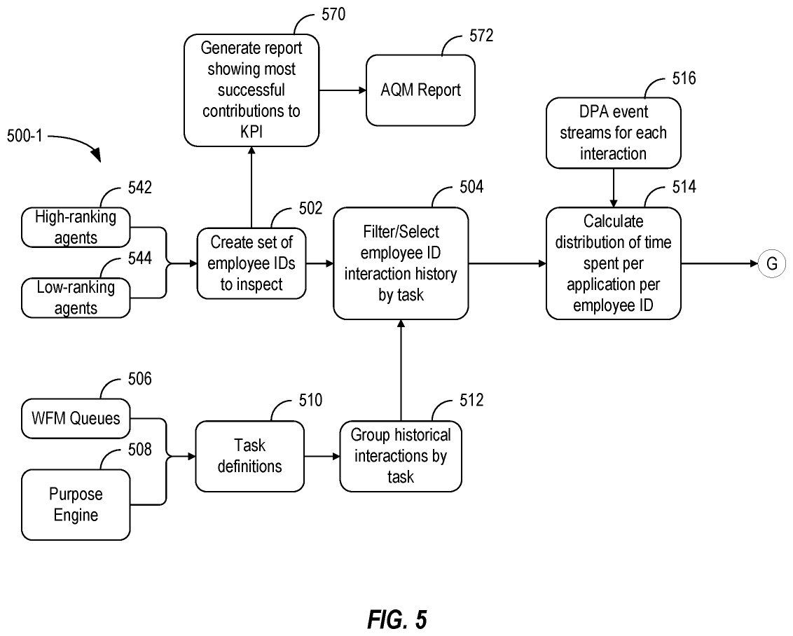

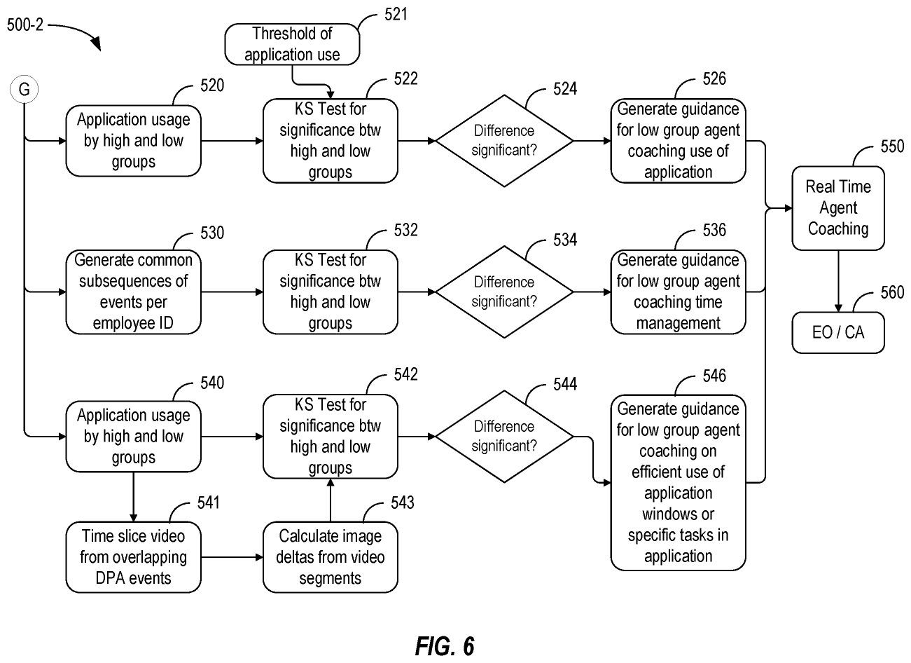

FIGS. 5 and 6 depict illustrative block diagrams 300-1 and 300-2 corresponding to an automated agent performance ranking process.

For concise explanation, repetition of steps previously described will be not be repeated here. That is, step 302 corresponds to step 124 depicted and described with reference to at least FIG. 1. Step 304 corresponds to step 128 depicted and described with reference to at least FIG. 1. For example, the model 525 corresponds to the model 125 depicted and described with reference to at least FIG. 1. Step 306 corresponds to prediction value 131 depicted and described with reference to at least FIG. 1.

Step 307 includes, for example, filtering out the features from the initial plurality of features (e.g., Feature 1, Feature 2, . . . , Feature n) that the contact center agent has no control over based on a set of predefined features determined to be in control of the agent. A filtered set of features (Feature j₁, Feature j₂, . . . , Feature jₘ) includes a subset of the initial plurality of n features.

Step 307 further includes creating partial dependence plots (PDP) for each of the filtered set of features. The partial dependence plots define a relationship between a change to a feature value and a probability of changing the KPI metric. For example, the x-axis of the PDP is changing the feature value. The y-axis of the PDP shows how much the prediction probability for the class (target KPI metric) changes. Therefore, the system can directly determine from the range of y in the PDPs the variations in predictive probability by changing the feature value.

Step 307 may also include utilizing the PDPs to determine variations in the predictive probability of the feature value. That is, step 307 may include determining the amount that a feature has to change so that the KPI metric meets the target value. Additionally, the features are sorted (high to low) based on the size of the potential improvement by ranking the variations. The larger the variation, the more room for improvement a feature is determined to be capable of providing

Step 308 and step 310 corresponds to step 134 and step 136, respectively, depicted and described with reference to at least FIG. 1.

As the aforementioned steps correspond to aspects and operations previously described, discussion herein begins with step 312. At step 312, a set of features that are determined to be controllable by an agent when engaged in a customer-agent interaction is received from step 310. The features that are determined to be controllable by the agent are further identified as being task-dependent, and if task-dependent correlated with the specific task. For example, interaction with a specific application by an agent to address an issue, such as resetting a password or processing a payment on an account, may be specific to the respective tasks of password reset and payment processing tasks.

At step 314, the automated agent performance ranking process receives a KPI metric that is chosen by a user (e.g., from step 304), a filtered set of features corresponding to those that are under an agent's control (e.g., from step 308), a list of features that are task dependent (e.g., from step 312), and historical interactions for a plurality of agents (e.g., from step 316). The historical interactions for a plurality of agents, from step 316, include customer-agent interaction data for a plurality of agents over a period of time. In some instances, the historical interactions do not include performance scores or other analytics. Rather, the historical interactions need to be analyzed, for example, by the model 325 (e.g., corresponding to model 125 depicted and described with reference to FIGS. 1-2), at step 314 to obtain a performance score for each feature in a plurality of customer-agent interactions. Accordingly, at step 314, the automated agent performance ranking process obtains, for each agent of a plurality of agents, a performance score for each feature in a plurality of customer-agent interactions provided in the historical interactions.

Step 314, in some aspects, generates a times series of an agent's performance per feature associated with a customer-agent interaction. Additionally, each feature is associated with a key performance index (KPI) metric and is under control of the agent. For example, the time series may be defined by predefined intervals of time and performance scores corresponding to features for interactions occurring during each predefined interval of time. The time series is initially generated as a data structure such as an array or a matrix. For example, each agent of the plurality of agents may have multiple time series. Each time series may be feature and/or task specific. However, visually, the time series provides a visual representation of performance, for example, depicted on a Y-axis of a graph with time defined on the X-axis. Whether the time series is produced as a visual representation or remains as a data structure for processes of the automated agent performance ranking process to utilize, trends, averages, and other statistical analysis can be performed to analyze performance of an agent over time.

For example, one of the plurality of customer-agent interactions may be a transcript of an interaction between a customer communicating with an agent at a contact center to have a password reset for one of their accounts. The customer-agent interaction may include one or more of the following quantifiable features: the time an agent spends talking during a call with a customer, the time a customer spends talking during the call, the number of interruptions in the call, time between an agent's start data and the call date, a call duration, a number of holds in the call, the time of mutual silence in the call, the screen module used in the call, KM searches conducted by the agent, CRM access patterns by the agent, or the like. The model 325 identifies and measures each feature to generate a predicted value for a KPI metric corresponding to the interaction. The model 325, also generates a performance score for each of the features in the customer-agent interaction.

Another example interaction may include a customer communicating with an agent at the contact center to make changes to beneficiary information on life insurance plan. The type of task can be determined at step 322 with a purpose engine 318 or a topic detection engine 320. The purpose engine 318 invokes a process configured to ingest a transcript of an interaction and generate a predicted intent or purpose of the interaction. For example, the purpose engine 318 may include an artificial intelligence based intent discovery model that is configured to ingest a transcript of an interaction and generate a predicted intent or purpose of the interaction. An example aspect of the intent discovery model is described in U.S. patent application Ser. No. 18/438,381, which is incorporated herein by reference in its entirety.

In some aspects, the type of task can be determined at step 322 with a topic detection engine 320 that employs natural language processing techniques to automatically extract meaning from text by identifying themes or topics. Step 322 may process and determine the purpose or topic in each of a plurality of customer-agent interactions provided in the historical interactions from step 316. Additionally, at step 322, a task label is assigned to each of the plurality of customer-agent interactions. In some aspects, the task label is the task type. In other aspects, the task label is a difficulty metric of the task. While, in yet other aspects, the task label comprises both a task type and a difficulty metric. The difficulty metric may be generated from a predefined rating assigned to each type of task.

Step 324 includes receiving performance scores for each of the plurality of agents from step 314 and task labels for each of the plurality of customer-agent interactions from step 322. Step 324 executes a process for grouping interaction history (e.g., the performance scores for each feature) for each agent based on the task label. That is, performance scores for each feature identified in the plurality of customer-agent interactions are grouped into one or more task groups based on the task label for each of the plurality of customer-agent interactions. The one or more task groups may be associated with a type of task, such as account access issues including resetting a password or billing including processing a payment on an account. The one or more task groups may be associated with a task difficulty metric. The aforementioned process of grouping may also be applied to grouping time series in the same manner, when time series per feature are provided by step 314 to step 324. For example, step 324 may execute a process for grouping each of the generated time series into the one or more task groups based on the task label for each of the plurality of customer-agent interactions.

The plurality of customer-agent interactions grouped by task in step 324 are received by step 326. Step 326 determines a task-feature performance value for each agent of the plurality of agents. As used herein, the term “task-feature performance value” refers to a combination of the performance scores specific to a particular feature and the task identified by the grouping in step 324. For example, for a contact center interaction, such as a call transcript, email, social posts, live chat, the large set of interaction data may further include an interaction identification (ID) (e.g., indicating unique interactions), an employee ID of the agent, a task ID corresponding to the task handled during the interaction, one or more feature IDs corresponding to features, along with one or more feature values, and a value for the KPI metric for the interaction.

Statistical analysis may be used to tell provide an indication as to the relationship between the one or more feature values and the value for the KPI metric over all interactions grouped by, for example, employee ID, task ID, and/or feature ID. The statistical relationship can indicate a feature value that optimizes the KPI metric in the desired direction. For example, if mutual silence is the feature, then through a regression or other means the relationship between the value of the feature “mutual science” and the desired KPI value (high CSAT, high NPS, low churn, etc) can be found. In some instances, the relationship indicates that as mutual silence time increases the KPI value decreases. The task-feature performance value may be a statistically determined value from the combination of performance scores or a time series of the performance scores for each task and feature combination.

In combination with determining that the feature of mutual silence is a highly impactful feature to a value for the KPI metric, insight into an agent's task and feature specific performance provides additional specificity into whether an agent's performance, good or poor, is driven more by the task, feature, or a combination of both. That is, determining the agent's performance with respect to specific features during the task specific activities helps identify whether there is a need for training on that feature, task, or combination. For example, if an agent's performance with respect to mutual silence is poor for a specific task, it is more likely that there is a need for training more geared towards the task rather than how to conduct a conversation with a customer to avoid negative instances of mutual silence.

At step 340, reports are generated ranking the agents based on their historical performance by features. Step 340 executes a process for generating, for each feature, a report comprising a ranking for each agent of the plurality of agents based on the task-feature performance value. For example, the report may include a listing of high-ranking agents 342 and a listing of low-ranking agents 344. In some aspects, the report comprises the time series for each agent of the plurality of agent. Ranking of the agents may include grouping agents into two or more groups. The groups may be associated with one or more threshold values, percentages, and/or total number of agents per grouping, such as agents having a task-feature performance value of better than 9 (out of 10), top and bottom 50%, top 10, 20, 30 or 40 agents per group or the like. As a further example, since the groups are ranked in a sorted order of highest score to lowest, the grouping of agents may be selected by taking top and/or bottom N number of agents, setting a high and/or low threshold based on a numeric score or based on a percentage, or taking the upper and lower quartile.

In some aspects, ranking of agents may include ranking human agents with other human agents and/or ranking human agents with one or more chatbot agents. In some aspects, to rank a group of agents that includes human agents and chatbot agents, features that are only relevant to chatbots may not be considered, unless the feature that is relevant to the chatbot can map to a corresponding human agent feature. For example, the human agent feature of the time a human agent spends talking on call may be considered equivalent to the chatbot agent feature of the amount of time a chatbot spent generating a response to an input. However, there may be instances where the feature value of the human agent feature and the chatbot agent feature, such as time in the aforementioned example, needs to be normalized in order to be compared for ranking the human agent and chatbot agent based on corresponding, but not exact same type of feature. The process of determining which features are relevant to human agents (e.g., controllable by human agents) and relevant to chatbot (e.g., associated with chatbots), may be determined based on the type of flag that is set in step 136 described with reference to FIG. 1 or step 310 as described with reference to FIG. 5.

The generated reports may be provided to an agent coaching application at step 350, where customized agent coaching is automatically generated and implemented, for example, absent the need for analysis and/or direction of a supervisor 360.

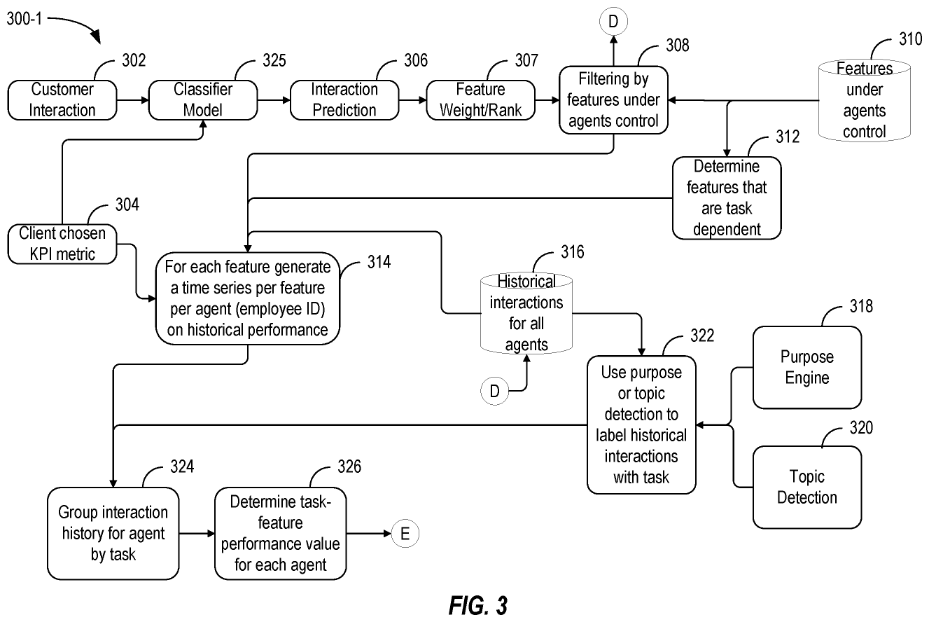

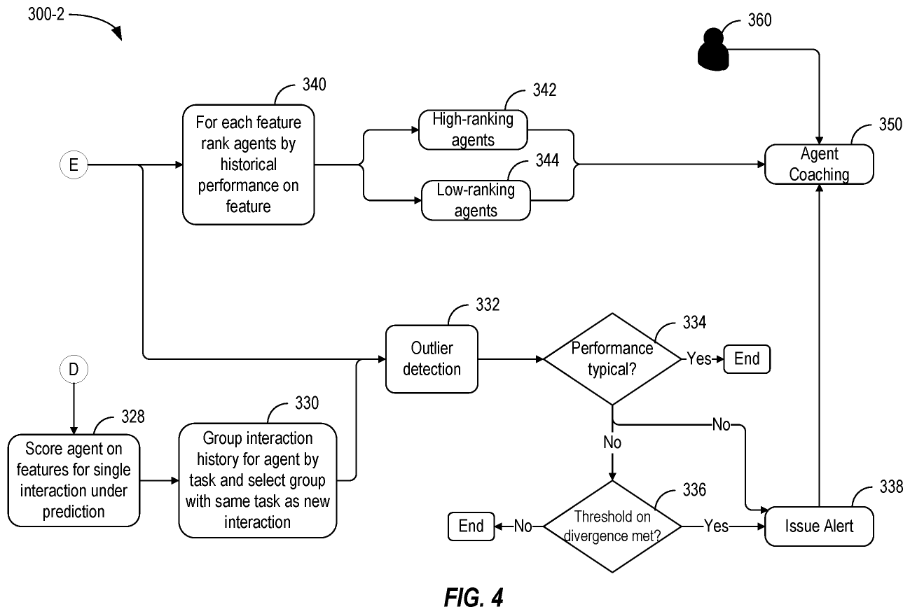

Still referring to the illustrative block diagrams 300-1 and 300-2 corresponding to an automated agent performance ranking process depicted in FIGS. 3 and 4, steps 328-338 provide a process for determining whether the performance of an agent is atypical from past performance and more specifically, whether their performance is trending in a negative direction. At step 328, the automated agent performance ranking process is configured to perform a process of generating, for a first agent of the plurality of agents, with a model 325 (e.g., classifier model 125), a predicted performance score for each feature in the new customer-agent interaction. The model 325 may be a model 125 as depicted and described with reference to FIG. 1, which may be configured to predict a value for the KPI metric and measure performance of features in a new customer-agent interaction.

Step 330 then groups interaction history for the agent by task and selects a group of the one or more task groups that corresponds to the task present in the new customer-agent interaction. The automated agent performance ranking process is configured to perform a process of associating the new customer-agent interaction with a corresponding one of the one or more task groups. The automated agent performance ranking process at step 330 is further configured to perform a process of selecting, from the corresponding one of the one or more task groups, the task-feature performance value associated with the first agent.

At step 332, an outlier detection process is applied based on the task-feature performance value for each agent of the plurality of agents determined at step 326 and the task group selection made at step 330. The outlier detection process includes comparing the predicted performance score for each feature in the new customer-agent interaction with the task-feature performance value for the corresponding one of the one or more task groups associated with the first agent. The comparison process generates a quantitative measure for further determining whether the agent's performance is typical and whether the agent's performance is trending in a negative direction.

As such, at step 334, the automated agent performance ranking process is configured to perform a process of determining, based on the comparison, whether the predicted performance score is within a predefined range of the task-feature performance value for the corresponding one of the one or more task groups associated with the first agent. If the predicted performance score is within a predefined range of the task-feature performance value, “Yes” at step 334, then no further action need be taken. However, if the predicted performance score is not within a predefined range of the task-feature performance value, “No” at step 334, then, in some aspects, the process proceeds to step 338, where the automated agent performance ranking process is configured to perform a process of outputting an indication that the predicted performance score is outside and below the predefined range. The indication may be an alert, a report, or a trigger which causes the agent coaching process at step 350 to be initiated.

In some aspects, if the predicted performance score is not within a predefined range of the task-feature performance value, “No” at step 334, then, the process proceeds to step 336, where the automated agent performance ranking process is configured to perform a process of determining whether the predicted performance score is part of a continuing trend of declining performance and the divergence in performance has met or exceeded a threshold performance value. To make the aforementioned determination, the automated agent performance ranking process may execute one or more intermediate processes. The one or more intermediate processes may include, obtaining, for the first agent, a time series of the task-feature performance value for the corresponding one of the one or more task groups.

Then, at step 336, a determination is made as to whether the predicted performance score indicates a continued decrease in performance based on the time series and the continued decrease meets or exceeds a divergence threshold. If the determination at step 336 concludes that the predicted performance score indicates a continued decrease in performance and meets or exceeds the divergence threshold, “Yes” at step 336, then the process proceeds to step 338, where the automated agent performance ranking process is configured to perform a process of outputting an indication. The indication may be an alert, a report, or a trigger which causes the agent coaching process at step 350 to be initiated.

If the determination at step 336 concludes that the predicted performance score does not indicate a continued decrease in performance and does not meet or exceed the divergence threshold, “No” at step 336, then then no further action may be taken.

### Aspects Related to Automated Agent Coaching

FIGS. 5 and 6 depict illustrative block diagrams 500-1 and 500-2 corresponding to an automated agent coaching process. The automated agent coaching processes described herein provide technical solutions for automatically analyzing interaction history, performance and task specific activities between groups of high and low performers.

At step 502, the automated agent coaching process implemented by an automated coaching application may be triggered in response to receiving an indication for example from the automated agent performance ranking process depicted and described herein with reference to FIGS. 3 and 4. However, this is not the only means by which the automated agent coaching process is initiated. The automated agent coaching process may be initiated by a supervisor or by other triggers indicating that agent training is needed. In some aspects, the automated agent coaching process may concurrently run while an agent is performing interactions with a customer so that near real-time coaching can be provided when activity or behaviors corresponding to features are determined to not align with best practices. The near real-time coaching may be presented to an agent during the interaction with a customer or following the interaction with the customer so that immediate training or reinforcement of positive performance may be attained.

At step 502, the automated agent coaching process obtains a ranking for each agent of a plurality of agents and a plurality of customer-agent interactions for each agent. The information may be provided in the form of a report that includes a listing of high-ranking agents at step 542 and a listing of low-ranking agents at step 544, such as the report generated by step 340 as depicted and described with reference to FIGS. 3 and 4. Ranking of the agents may include grouping agents into two or more groups. The groups may be delineated by one or more threshold values, percentages, and/or total number of agents per grouping. A first group of agents may corresponds to one or more agents of the plurality of agents having a ranking, for example, above a first threshold. The second group may correspond to one or more agents of the plurality of agents having a ranking below a second threshold. The first and second threshold may be determined such that the first group includes a top n number of agents and the second group include a bottom n number of agents. The first and second threshold may be determined such that the first group includes a top n percentage of agents and the second group include a bottom n percentage of agents. These are only examples of how the first and second thresholds may be defined.

In some aspects, at step 502 a subset of the plurality of agents may be identified and selected for coaching. For those agents that are determined as being high-performing, at step 570, a report may be generated indicating which areas of performance contribute to positive KPI metrics. The report may be an automated quality management (AQM) report 572, which is generated and utilized by AQM systems.

Proceeding from step 502, automated agent coaching process continues with step 504. Step 504 receives the ranking for each agent of the plurality of agents and any subset thereof determined by step 502. Step 504 further receives groupings of the plurality of customer-agent interactions (e.g., historical interactions) for each agent from the step 512 as generated by the process of step 506 and 510 and the purpose engine 508. The plurality of customer-agent interactions are provided to step 510 from the workforce management queues included in step 506. Additionally, the detected purpose in each of the plurality of customer-agent interactions as determined by the purpose engine 508 (e.g., the purpose engine 318 as described with reference to FIG. 3) is provided to step 510. Step 510 employs task definitions (which may be predefined) for task groupings. Step 512 uses the task definitions to label and group the plurality of customer-agent interactions by task.

Step 504 selects a first set of customer-agent interactions from the plurality of customer-agent interactions corresponding to a first task label. The first set of customer-agent interactions proceeds to step 514 where the task similar interactions begin substantive analysis for determining automated agent coaching modules to deploy.

Step 514 receives or retrieves from step 516, application event streams corresponding to the first set of customer-agent interactions. The application event streams comprise agent application usage data obtained during a customer-agent interaction. For example, the application event streams contain logs of actions an agent takes on their computing device while interacting with customer-agent interaction applications during a customer-agent interaction. The application event streams may include applications used, searches conducted, keystrokes and/or input made by the agent, sequences of events, and the like. The application event streams may be captured and fed into step 514 in near real-time or may be correlated and stored in a data storage location for later use by an application such as the automated coaching application described herein.

The automated agent coaching process continues with analyzing the application event streams for statistically relevant differences for one or more activities performed by a first group of the plurality of agents compared to a second group of the plurality of agents at steps 520-524, 530-534, and 540-544. As noted above, the first group is identified as higher performing agents compared to the second group based on the ranking. When the analysis from steps 520-524, 530-534, and 540-544 indicates there is a statistically relevant difference between the high and low-performing groups of agents, the process proceeds to steps 526, 536, and/or 546 where guidance corresponding to the least one activity for the second group is generated.

Steps 520-524, 530-534, and 540-544 provide exemplary analysis processes that may be carried out by the automated agent coaching process. However, it is understood that there may be other specific processes capable of being implemented for analyzing the application event streams for statistically relevant differences between high and low-performing groups of agents.

For example, at step 520, application usage for each of the groups (e.g., high performance group of agents and low performance group of agents) is determined from the application event streams. Step 522 may implement a Kolmogorov-Smirnov (KS) test for determining statistical significance between the groups based on a threshold for application usage time received from step 521, optionally set by a user of the system. The KS test provides an indication as to whether the value distribution for the high performing agent group is significantly different than the value distribution for the low performing agent group. If the difference between the groups is significant according to the KS test, training may be issued for the low performing agent group on that application or feature as it could improve their performance. However, other statistical significance tests could be applied. When the application usage time between the first group and the second group is different and exceeds a threshold for application usage time as determined by step 524, the process proceeds to step 526 where guidance corresponding coaching on use of an application is generated.

By way of another example, at step 530, common sequences of events for each of the groups (e.g., high performance group of agents and low performance group of agents) is determined from the application event streams. Step 532 may implement a KS test for significance between the groups. When the common sequences of events between the first group and the second group is different by a statically relevant measure as determined by step 534, the process proceeds to step 536 where guidance corresponding coaching on time management is generated.

By way of another example, at step 540, application usage based on analysis of time slices of video overlapping application events is determined with steps 541 and 543. Steps 541 and 543 slice video from overlapping portions of application events (step 541) and determine deltas in the video segments (step 543) as a way to determine actions taken by an agent. Step 542 implements a KS test for significance between the groups. When a statically relevant difference between the groups is determined by step 544, the process proceeds to step 536 where guidance corresponding coaching on efficient use of application windows or specific tasks in application is generated.

Step 550 includes deploying the generated guidance to the second group. The guidance may be deployed in near real-time or as training modules one or more agents can complete when not engaged in a customer-agent interaction. For example, guidance can be sent to agent coaching applications for offline training recommendations, or for online coaching, such as pop-up reminders during an interaction to use applications or features observed to be used by high-performing groups. Deployment of the real time agent coaching may be sent to Engagement Orchestration (EO)/Channel Automation (CA) at step 560.

The automated agent coaching process described herein includes specific guidance created by subject matter experts or automatically generated for situations where application usage is not present in low-performing groups. For example, if a low-performing group is observed not using an application or feature of an application that is used by the high-performing group, the automated agent coaching process can automatically suggest training or coaching on that application.

High-performing groups are measured by their positive contribution to company-determined KPIs. Those in the high-performing groups can be recognized as impactful to the KPI through automated badges, notifications, or recommendations to their supervisors through AQM. This gives direct feedback to the agents on their positive contributions to the company success.

For application specific tasks, a desktop process and analysis (DPA) system can collect events of application window time duration to segment the screen recording video to the applications usage. The images of the application usage from high-performing groups are compared to images of applications usage of low-performing groups to look for differences in application. If long time lags are spent on the same screen, as determined by low pixel changes over time, with the low-performing group versus the high-performing group on the same screen, it can be inferred that the low-performing group is unfamiliar or confused with the usage of that application screen. Accordingly, a training suggestion to the low-performing group on the proper usage of that specific feature can be automatically generated. The feature the agents are spending long time periods on can be determined by applying OCR to the video image to extract the text of the application screen and match this with the user guide text to determine the documentation the low-performing group should review.

Guidance can be sent to agent coaching applications for offline training recommendations, or for online coaching such as pop-up reminders during an interaction to use applications or features observed to be used by high-performing groups.

### Additional Aspects Related to Automated Agent Coaching

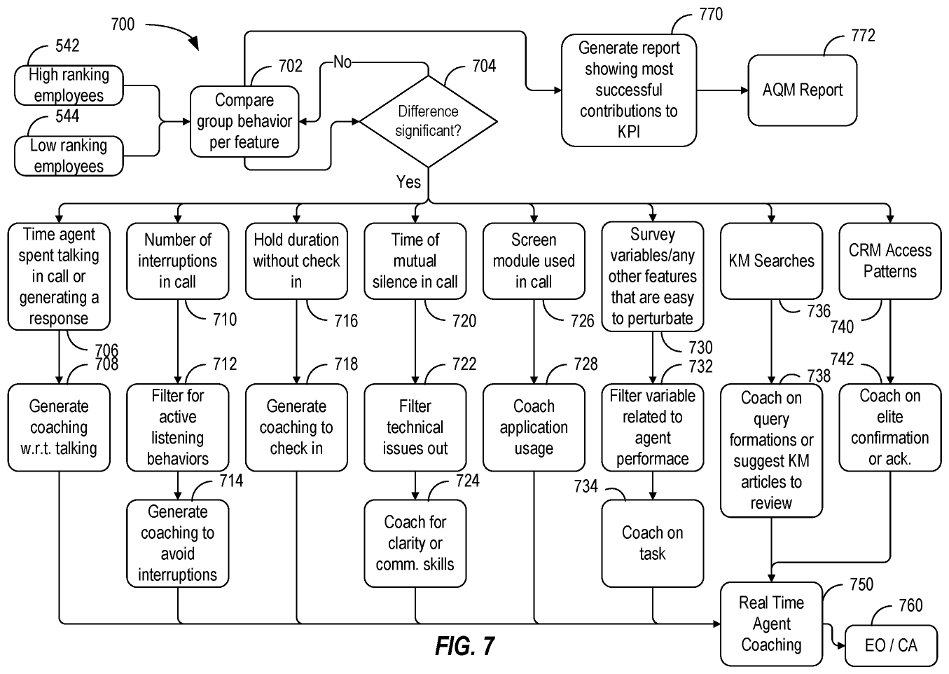

FIG. 7 schematically depicts an illustrative block diagram 700 for further aspect of the automated agent coaching process depicted in FIGS. 5 and 6. The automated agent coaching processes described herein may operate as an extension of aspects of the automated agent coaching process depicted and described with reference to FIGS. 5 and 6. Some aspects of the automated agent coaching processes, for example as described with reference to FIG. 7, may operate independently of the aforementioned processes.

At step 702, the automated agent coaching process implemented by an automated coaching application may be triggered in response to receiving an indication, for example from the automated agent performance ranking process depicted and described herein with reference to FIGS. 3 and 4. However, this is not the only means by which the automated agent coaching process is initiated. The automated agent coaching process may be initiated by a supervisor or by other triggers indicating that agent training is needed. In some aspects, the automated agent coaching process may concurrently run while an agent is performing interactions with a customer so that near real-time coaching can be provided when activity or behaviors corresponding to features are determined to not align with high-performing practices. The near real-time coaching may be presented to an agent during the interaction with a customer or following the interaction with the customer so that immediate training or reinforcement of positive performance may be attained.

At step 702, the automated agent coaching process obtains a ranking for each agent of a plurality of agents and a plurality of customer-agent interactions for each agent. The information may be provided in the form of a report that includes a listing of high-ranking agents from step 542 and a listing of low-ranking agents from step 544, such as the report generated by step 340 as depicted and described with reference to FIGS. 3 and 4. Ranking of the agents may include grouping agents into two or more groups. The groups may be delineated by one or more threshold values, percentages, and/or total number of agents per grouping. A first group of agents may corresponds to one or more agents of the plurality of agents having a ranking, for example, above a first threshold. The second group may correspond to one or more agents of the plurality of agents having a ranking below a second threshold. The first and second threshold may be determined such that the first group includes a top n number of agents and the second group include a bottom n number of agents. The first and second threshold may be determined such that the first group includes a top n percentage of agents and the second group include a bottom n percentage of agents. These are only examples of how the first and second thresholds may be defined.

In some aspects, at step 702 a subset of the plurality of agents may be identified and selected to inspect for coaching. For those agents that are determined as being high-performing, at step 770 a report may be generated indicating which areas of performance contribute to positive KPI metrics. The report may be an AQM report 772, which is generated and utilized by AQM systems.

At step 702, the automated agent coaching process obtains a ranking for each agent of a plurality of agents and a plurality of customer-agent interactions as discussed above. Step 702 then proceeds with analyzing, per feature, the plurality of customer-agent interactions for statistically relevant differences in behavior by a first group of the plurality of agents compared to a second group of the plurality of agents.

Step 704 determines whether at least one feature where the behavior of the first group corresponding to the at least one features is different than the second group. Analysis of the plurality of customer-agent interactions can include assessing and measuring agents behavior associated with features such as a time an agent spending talking, a number of agent interruptions, a duration of a hold without the agent checking in with the customer, a time of mutual silence, amount of time a chatbot spent generating a response to an input, use of an application, a number of knowledge management searches conducted by the agent, usage pattern of a customer relationship management tool, or survey variables or other features that can be extracted from the customer-agent interaction.

In other words, assuming the pre-existence of rankings produced by survey data or an outcome classifier trained on survey data, a high-ranking and low-ranking agent group can be determined via a top or bottom n scheme, wherein the user chooses the value of n or the value of n can be a value based on a threshold. For the high-ranking agent group, their achievements can be acknowledged by generating an AQM report showing their successful contributions to the KPI.

The automated agent coaching process then compares the two groups feature by feature to generate feedback. In some aspects, for example, when the agent is a chatbot, the generated feedback may be an indication that the chatbot requires updating or additional training with respect to a feature corresponding to the lower performance, when compared to other agents having better performance on the same or a corresponding feature. For example, at step 706, for the feature of the amount of time an agent spent talking on call, if the agent does not speak enough, the customer may not get his or her question answered and may feel confused or ignored. Coaching could involve telling the agent to be more conscientious and talk more at step 708. In a similar example, at step 706, a chatbot specific feature of amount of time a chatbot spent generating a response to an input may be normalized and compared with the human agents' performance related to the amount of time the human agent spent talking. When a chatbot is the agent type indicated as requiring coaching, the coaching generated at step 708 may include setting a flag in the system to execute additional training of the chatbot with respect to a particular subject matter that the chatbot was slow at generating a response for or another type of reconfiguration to improve the chatbot's response time. While other examples discussed herein are generally directed to improving human agent performance with coaching it should be understood that chabot agents may also be assessed through similar processes and coaching provided through automatic execution or deployment of additional supervised or unsupervised training techniques directed to improving performance with respect to a feature the chatbot is determined to have low performance.

For the feature of a number of interruptions on call, at step 710, it may be determined that the agent interrupts the user too much. However, not all interruptions are bad. Sometimes, in a conversation a participant may make sounds of acknowledgement such as “ok” which would be counted as an interruption in the system but should not be considered a bad one. The automated agent coaching process at step 712 filters for active listening behaviors prior to counting interruptions and generating coaching at step 714.

At step 716, for the feature of hold duration without check-in, the analysis considers the feature of hold duration and the number of check-ins, for high-ranking agents compared to low-ranking agents and provides feedback to the agent when the frequency of check-ins is too low by comparison. That is, the agent can be advised to check back more frequently when the customer is put on hold at step 718.

At step 720, for the feature of time of mutual silence in call, first, the automated agent coaching process filters out technical issues (e.g., connection) that can create periods of time where participants cannot hear each other at step 722. Once filtered, the automated agent coaching process can determine times where there is too much silence, especially on the agent's part (if he or she is in the low-ranking group). Coaching for clarity and communication skills can help customers understand the agent better and reduce mutual silence at step 724.

Regarding features associate with screen module usage at step 726, if the high-ranking group is using a particular module/application more than the low-ranking group, the low-ranking group should be encouraged to use that application more or be trained on it at step 728.

At step 730, regarding survey variables, automated agent coaching process can determine which variables are related to agent performance and are within the agent's control (e.g., Did the agent answer all of your questions?), at step 732, and for each question in the survey the survey creator can specify coaching directly on that survey question at step 734.

With respect to KM searches at step 736, this feature is generally correlated to the amount of experience the agent has. If the agent performs multiple searches per caller issue, it may indicate the agent is not sure what to look for in KM. Coaching at step 738 could be provided on how to formulate the search query, or the agent can be told to read certain articles that can aid in fewer KM searches overall needed.

At step 740, CRM access patterns can provide the indication that agents in the low-ranking group are not helping customers enough by taking advantage of their loyalty benefits. In this instance, at step 742, the automated agent coaching process can coach agents on thanking the customer for their loyalty and how to confirm with customers on their elite status, loyalty program participation, etc. and how to take advantage of the program's benefits.

Additional features can be used and linked to specific agent coaching behaviors. All these features can be used to generate agent feedback that can be used for real time agent coaching at step 750. Deployment of the real time agent coaching may be sent to EO/CA at step 760. In some aspects, deployment of the real time agent coaching may include executing an update or additional training processes for a chatbot agent at step 760.

### Example Methods for Providing an Automated Agent Coaching

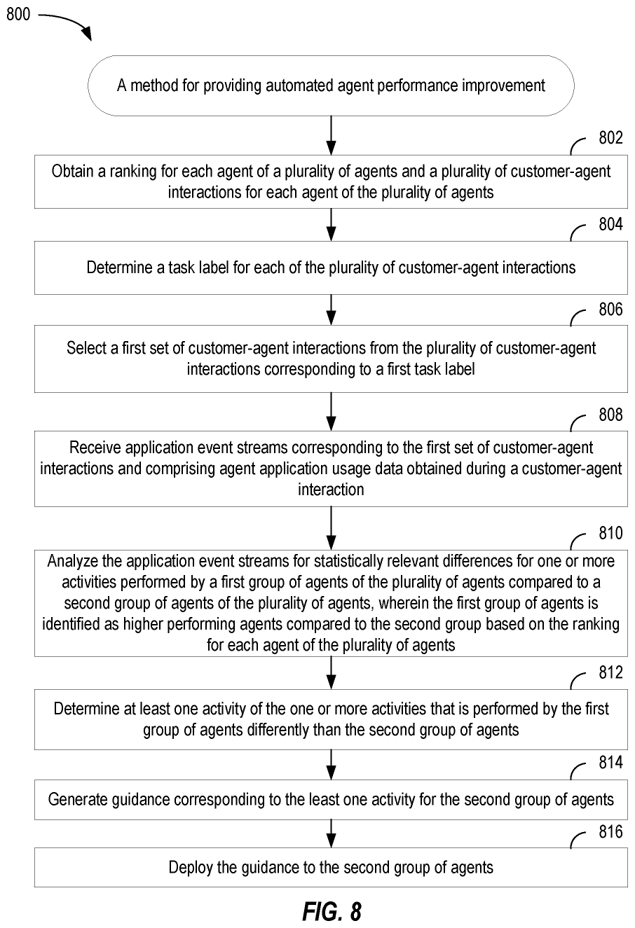

FIG. 8 depicts an example method for providing an intent expressed in a conversational interaction in a narrative form.

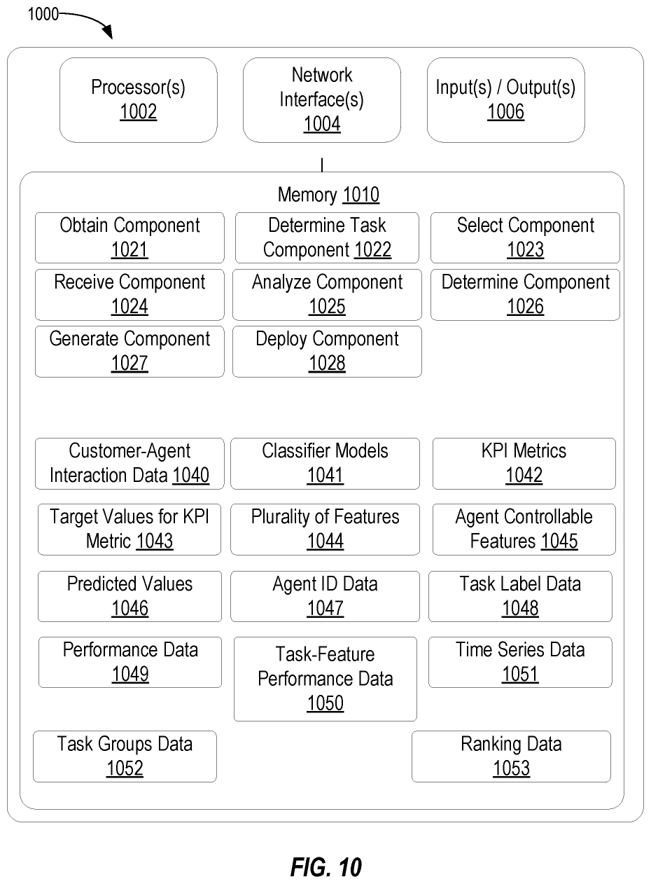

In this example, method 800 begins at step 802 obtaining a ranking for each agent of a plurality of agents and obtaining a plurality of customer-agent interactions for each agent of the plurality of agents. For example, step 802 may be performed by the apparatus 1000 as described herein with reference to FIG. 10 that is configured to perform at least the process corresponding to steps 502, 542, 544 as described above with reference to at least FIGS. 5 and 6.

Method 800 proceeds to step 804 with determining a task label for each of the plurality of customer-agent interactions. For example, step 804 may be performed by the apparatus 1000 as described herein with reference to FIG. 10 that is configured to perform the process corresponding to step 812 as described above with reference to at least FIGS. 5 and 6.

Method 800 proceeds to 806 with selecting a first set of customer-agent interactions from the plurality of customer-agent interactions corresponding to a first task label. For example, step 806 may be performed by the apparatus 1000 as described herein with reference to FIG. 10 that is configured to perform the process corresponding to step 504 as described above with reference to at least FIGS. 5 and 6.

Method 800 proceeds to 808 with receiving application event streams corresponding to the first set of customer-agent interactions and comprising agent application usage data obtained during a customer-agent interaction. For example, step 808 may be performed by the apparatus 1000 as described herein with reference to FIG. 10 that is configured to perform the process corresponding to step 516 as described above with reference to at least FIGS. 5 and 6.

Method 800 proceeds to 810 with analyzing the application event streams for statistically relevant differences for one or more activities performed by a first group of agents of the plurality of agents compared to a second group of agents of the plurality of agents, wherein the first group of agents is identified as higher performing agents compared to the second group of agents based on the ranking for each agent of the plurality of agents. For example, step 810 may be performed by the apparatus 1000 as described herein with reference to FIG. 13 that is configured to perform the process corresponding to steps 514, 520, 522, 530, 532, 540, 542 as described above with reference to at least FIGS. 5 and 6.

Method 800 proceeds to 812 with determining at least one activity of the one or more activities that is performed by the first group of agents differently than the second group of agents. For example, step 812 may be performed by the apparatus 1000 as described herein with reference to FIG. 10 that is configured to perform the process corresponding to steps 524, 534, 544 as described above with reference to at least FIGS. 5 and 6.

Method 800 proceeds to 814 with generating guidance corresponding to the least one activity for the second group of agents. For example, step 814 may be performed by the apparatus 1000 as described herein with reference to FIG. 10 that is configured to perform the process corresponding to steps 526, 536, 546 as described above with reference to at least FIGS. 5 and 6.

Method 800 proceeds to 816 with deploying the guidance to the second group of agents. For example, step 816 may be performed by the apparatus 1000 as described herein with reference to FIG. 10 that is configured to perform the process corresponding to step 850 as described above with reference to at least FIGS. 5 and 6.

In some aspects, the method 800 further includes wherein the first group of agents corresponds to one or more agents of the plurality of agents having a ranking above a first threshold and the second group of agents corresponds to one or more agents of the plurality of agents having a ranking below a second threshold.

In some aspects, the method 800 further includes wherein analyzing the application event streams for statistically relevant differences comprises comparing application usage time between the first group of agents and the second group of agents.

In some aspects, the method 800 further includes wherein when the application usage time between the first group of agents and the second group of agents is different and exceeds a threshold for application usage time, generating the guidance comprises coaching on use of an application.

In some aspects, the method 800 further includes wherein analyzing the application event streams for statistically relevant differences comprises comparing a sequence of events performed by the first group of agents compared to the second group of agents.

In some aspects, the method 800 further includes wherein when the sequence of events for the first group of agents is different from the sequence of events for the second group of agents, generating the guidance comprises coaching on a process of handling a task corresponding to the first task label.

In some aspects, the method 800 further includes wherein the guidance is deployed to an agent of the second group of agents in near real-time during the customer-agent interaction.

Note that FIG. 8 is just one example of a method, and other methods including fewer, additional, or alternative steps are possible consistent with this disclosure. Automatic and tailored coaching provides a technical benefit of providing efficient and effective training that directly relates to improvement potential for the agent and furthermore increasing and/or maintaining a target value for a KPI metric. The processes described herein improve the technical operations of a contact center by providing active coaching modules to agents, for example, during a customer-agent interaction or in near real-time following the conclusion of the interaction. Accordingly, contact center performance and operations are improved post interaction surveys are not required and feedback to agents is not delayed by supervisors parsing through immense and unmanageable amounts of interaction data to determine metrics for improving the performance of agents.

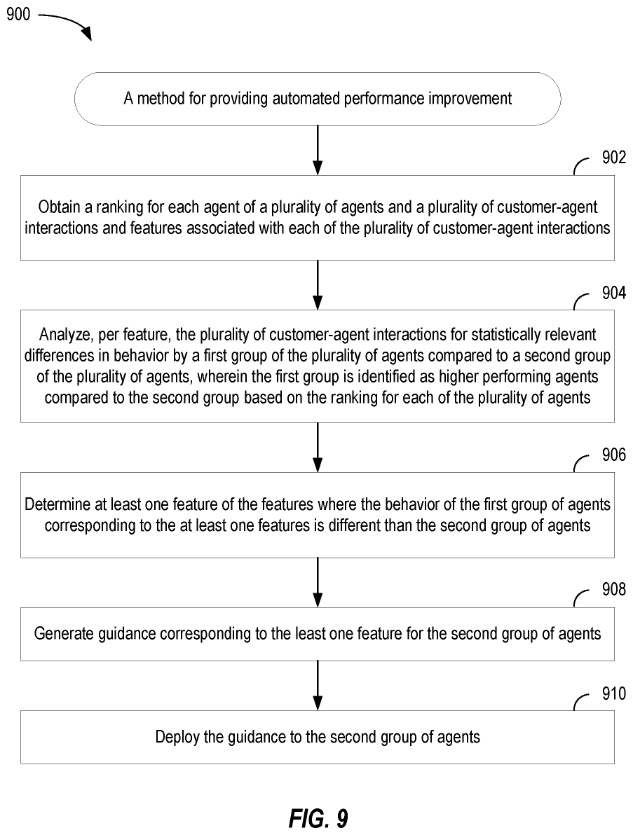

FIG. 9 depicts an example method for providing an intent expressed in a conversational interaction in a narrative form.

In this example, method 900 begins at step 902 obtaining a ranking for each agent of a plurality of agents and obtaining a plurality of customer-agent interactions and features associated with each of the plurality of customer-agent interactions. For example, step 902 may be performed by the apparatus 1000 as described herein with reference to FIG. 10 that is configured to perform at least the process corresponding to step 702 as described above with reference to at least FIG. 7.

Method 900 proceeds to step 904 with analyzing, per feature, the plurality of customer-agent interactions for statistically relevant differences in behavior by a first group of agents of the plurality of agents compared to a second group of agents of the plurality of agents, wherein the first group is identified as higher performing agents compared to the second group or agents based on the ranking for each of the plurality of agents. For example, step 904 may be performed by the apparatus 1000 as described herein with reference to FIG. 10 that is configured to perform the process corresponding to step 702 as described above with reference to at least FIG. 7.

Method 900 proceeds to 906 with determining at least one feature of the features where the behavior of the first group of agents corresponding to the at least one features is different than the second group of agents. For example, step 906 may be performed by the apparatus 1000 as described herein with reference to FIG. 10 that is configured to perform the process corresponding to steps 706, 710, 716, 720, 726, 730, 736, and 740 as described above with reference to at least FIG. 7.

Method 900 proceeds to 908 with generating guidance corresponding to the least one feature for the second group of agents. For example, step 908 may be performed by the apparatus 1000 as described herein with reference to FIG. 10 that is configured to perform the process corresponding to steps 708, 712, 714, 718, 722, 724, 728, 732, 738, and 742 as described above with reference to at least FIG. 7.

Method 900 proceeds to 9110 with deploy the guidance to the second group of agents. For example, step 910 may be performed by the apparatus 1000 as described herein with reference to FIG. 1 that is configured to perform the process corresponding to steps 750 as described above with reference to at least FIG. 7.

Note that FIG. 9 is just one example of a method, and other methods including fewer, additional, or alternative steps are possible consistent with this disclosure.

### Example Apparatus for Providing an Automated Agent Coaching

FIG. 10 depicts an example apparatus 1000 configured to perform the methods described herein.

Apparatus 1000 includes one or more processors 1002. Generally, processor(s) 1002 may be configured to execute computer-executable instructions (e.g., software code) to perform various functions, as described herein.

Apparatus 1000 further includes a network interface(s) 1004, which generally provides data access to any sort of data network, including personal area networks (PANs), local area networks (LANs), wide area networks (WANs), the Internet, and the like.

Apparatus 1000 further includes input(s) and output(s) 1006, which generally provide means for providing data to and from apparatus 1000, such as via connection to computing device peripherals, including user interface peripherals.

Apparatus 1000 further includes a memory 1010 configured to store various types of components and data.

In this example, memory 1010 includes an obtain component 1021, a determine task component 1022, a select component 1023, a receive component 1024, an analyze component 1025, a determined component 1026, a generate component 1027, and a deploy component 1028.

The obtain component 1021 is configured to perform steps 502, 542, 544 of the method 500 depicted and described with reference to FIGS. 5 and 6, step 702 of the block diagram 700 depicted and described with reference to FIG. 7, step 802 of the automated agent coaching process depicted and described with reference to FIG. 8 and/or, step 902 of the automated agent coaching process depicted and described with reference to FIG. 9.

The determine task component 1022 is configured to perform step 512 of the method 500 depicted and described with reference to FIGS. 5 and 6, and/or step 804 of the automated agent coaching process depicted and described with reference to FIG. 8.

The select component 1023 is configured to perform step 504 of the method 500 depicted and described with reference to FIGS. 5 and 6, and/or step 806 of the automated agent coaching process depicted and described with reference to FIG. 8.

The receive component 1024 is configured to perform step 516 of the method 500 depicted and described with reference to FIGS. 5 and 6, and/or step 808 of the automated agent coaching process depicted and described with reference to FIG. 8.

The analyze component 1025 is configured to perform steps 514, 520, 522, 530, 532, 540, 542 as described above with reference to at least FIGS. 5 and 6, step 702 as described above with reference to at least FIG. 7, step 810 of the automated agent coaching process depicted and described with reference to FIG. 8 and/or, step 904 of the automated agent coaching process depicted and described with reference to FIG. 9.

The determine component 1026 is configured to perform steps 524, 534, 544 as described above with reference to at least FIGS. 5 and 6, steps 706, 710, 716, 720, 726, 730, 736, and 740 as described above with reference to at least FIG. 7, step 812 of the automated agent coaching process depicted and described with reference to FIG. 8 and/or, step 906 of the automated agent coaching process depicted and described with reference to FIG. 9.

The generate component 1027 is configured to perform steps 526, 536, 546 as described above with reference to at least FIGS. 5 and 6, steps 708, 712, 714, 718, 722, 724, 728, 732, 738, and 742 as described above with reference to at least FIG. 7, step 814 of the automated agent coaching process depicted and described with reference to FIG. 8 and/or, step 908 of the automated agent coaching process depicted and described with reference to FIG. 9.

The deploy component 1028 is configured to perform step 550 as described above with reference to at least FIGS. 5 and 6, step 750 as described above with reference to at least FIG. 7, step 816 of the automated agent coaching process depicted and described with reference to FIG. 8 and/or, step 910 of the automated agent coaching process depicted and described with reference to FIG. 9.

In this example, memory 1010 also includes at least the following, customer-agent interaction data 1040, classifier models 1041, KPI metrics 1042, target value for KPI metric 1043, plurality of features 1044, agent controllable features 1045, predicted values 1046, agent ID data 1047 corresponding to the plurality of agents, task label data 1048, performance data 1049, task-feature performance data 1050, time series data 1051, task group data 1052, and ranking data 1053 as described herein.

Apparatus 1000 may be implemented in various ways. For example, apparatus 1000 may be implemented within on-site, remote, or cloud-based processing equipment.

Apparatus 1000 is just one example, and other configurations are possible. For example, in alternative embodiments, aspects described with respect to apparatus 1000 may be omitted, added, or substituted for alternative aspects.

### Example Clauses

Implementation examples are described in the following numbered clauses:

Clause 1: A method for providing automated agent coaching, comprising: obtaining a ranking for each agent of a plurality of agents; obtaining a plurality of customer-agent interactions for each agent of the plurality of agents; determining a task label for each of the plurality of customer-agent interactions; selecting a first set of customer-agent interactions from the plurality of customer-agent interactions corresponding to a first task label; receiving application event streams corresponding to the first set of customer-agent interactions and comprising agent application usage data obtained during a customer-agent interaction; analyzing the application event streams for statistically relevant differences for one or more activities performed by a first group of agents of the plurality of agents compared to a second group of agents of the plurality of agents, wherein the first group of agents is identified as higher performing agents compared to the second group of agents based on the ranking for each agent of the plurality of agents; determining at least one activity of the one or more activities that is performed by the first group of agents differently than the second group of agents; generating guidance corresponding to the least one activity for the second group of agents; and deploying the guidance to the second group of agents.

Clause 2: The method of Clause 1, wherein the first group of agents corresponds to one or more agents of the plurality of agents having a ranking above a first threshold and the second group of agents corresponds to one or more agents of the plurality of agents having a ranking below a second threshold.

Clause 3: The method of any one of Clauses 1-2, wherein analyzing the application event streams for statistically relevant differences comprises comparing application usage time between the first group of agents and the second group of agents.

Clause 4: The method of Clause 3, wherein the application usage time between the first group of agents and the second group of agents is different and exceeds a threshold for application usage time, generating the guidance comprises coaching on use of an application.

Clause 5: The method of any one of Clauses 1-4, wherein analyzing the application event streams for statistically relevant differences comprises comparing a sequence of events performed by the first group of agents compared to the second group of agents.

Clause 6: The method of Clause 5, wherein the sequence of events for the first group of agents is different from the sequence of events for the second group of agents, generating the guidance comprises coaching on a process of handling a task corresponding to the first task label.

Clause 7: The method of any one of Clauses 1-6, wherein the guidance is deployed to an agent of the second group of agents in near real-time during the customer-agent interaction.

Clause 8: A method for providing automated agent coaching, comprising: obtaining a ranking for each agent of a plurality of agents obtaining a plurality of customer-agent interactions and features associated with each of the plurality of customer-agent interactions; analyzing, per feature, the plurality of customer-agent interactions for statistically relevant differences in behavior by a first group of agents of the plurality of agents compared to a second group of agents of the plurality of agents, wherein the first group of agents is identified as higher performing agents compared to the second group of agents based on the ranking for each of the plurality of agents; determining at least one feature of the features where the behavior of the first group of agents corresponding to the at least one feature is different than the second group of agents; generating guidance corresponding to the least one feature for the second group of agents; and deploying the guidance to the second group of agents.

Clause 9: The method of Clause 8, further comprising: receiving application event streams corresponding to the plurality of customer-agent interactions comprising agent application usage data obtained during a customer-agent interaction; analyzing the application event streams for statistically relevant differences for one or more activities performed by the first group of agents compared to the second group of agents; determining at least one activity of the one or more activities that is performed by the first group of agents differently than the second group of agents; and generating guidance corresponding to the least one activity for the second group of agents.

Clause 10: The method of any one of Clauses 7-9, wherein the first group of agents corresponds to one or more agents of the plurality of agents having a ranking above a first threshold and the second group of agents corresponds to one or more agents of the plurality of agents having a ranking below a second threshold.

Clause 11: The method of any one of Clauses 7-10, wherein the feature during a customer-agent interaction comprises at least one of: a time an agent spending talking, a number of agent interruptions, a duration of a hold without the agent checking in with the customer, a time of mutual silence, use of an application, a number of knowledge management searches conducted by the agent, or a usage pattern of a customer relationship management tool.

Clause 12: The method of any one of Clauses 7-11, wherein the guidance generated comprises at least one of: a coaching module with respect to talking with a customer, a coaching module regarding active listening behavior, a coaching module on how to implement frequent check-ins with the customer, a coaching module with respect to communication skills, a coaching module on how to use an application, a coaching module on performing knowledge management searches, or a coaching module on utilizing a customer relationship management tool for interacting with a customer.

Clause 13: The method of any one of Clauses 7-12, wherein the guidance is deployed to an agent of the second group of agents in near real-time during a customer-agent interaction.

Clause 14: A processing system, comprising: a memory comprising computer-executable instructions; and a processor configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium comprising computer-executable instructions that, when executed by a processor of a processing system, cause the processing system to perform a method in accordance with any one of Clauses 1-13.

Clause 17: A computer program product embodied on a computer-readable storage medium comprising code for performing a method in accordance with any one of Clauses 1-13.

### Additional Considerations

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments, but should be defined only in accordance with the following claims and their equivalents.

What is claimed is:

1. A method for providing automated agent performance improvement, comprising:
obtaining a ranking for each agent of a plurality of agents;
obtaining a plurality of customer-agent interactions for each agent of the plurality of agents;
determining a task label for each of the plurality of customer-agent interactions;
selecting a first set of customer-agent interactions from the plurality of customer-agent interactions corresponding to a first task label;
receiving application event streams corresponding to the first set of customer-agent interactions and comprising agent application usage data obtained during a customer-agent interaction;
analyzing the application event streams for statistically relevant differences for one or more activities performed by a first group of agents of the plurality of agents compared to a second group of agents of the plurality of agents, wherein the first group of agents is identified as higher performing agents compared to the second group of agents based on the ranking for each agent of the plurality of agents;
determining at least one activity of the one or more activities that is performed by the first group of agents differently than the second group of agents;
generating guidance corresponding to the least one activity for the second group of agents; and
deploying the guidance to the second group of agents.

2. The method of claim 1, wherein the first group of agents corresponds to one or more agents of the plurality of agents having a ranking above a first threshold and the second group of agents corresponds to one or more agents of the plurality of agents having a ranking below a second threshold.

3. The method of claim 1, wherein analyzing the application event streams for statistically relevant differences comprises comparing application usage time between the first group of agents and the second group of agents.

4. The method of claim 3, wherein the application usage time between the first group of agents and the second group of agents is different and exceeds a threshold for application usage time, generating the guidance comprises coaching on use of an application.

5. The method of claim 1, wherein analyzing the application event streams for statistically relevant differences comprises comparing a sequence of events performed by the first group of agents compared to the second group of agents.

6. The method of claim 5, wherein the sequence of events for the first group of agents is different from the sequence of events for the second group of agents, generating the guidance comprises coaching on a process of handling a task corresponding to the first task label.

7. The method of claim 1, wherein the guidance is deployed to an agent of the second group of agents in near real-time during the customer-agent interaction.

8. An apparatus configured for providing automated agent performance improvement, comprising: one or more memories comprising processor-executable instructions; and one or more processors configured to execute the processor-executable instructions and cause the apparatus to:
obtain a ranking for each agent of a plurality of agents;
obtain a plurality of customer-agent interactions for each agent of the plurality of agents;
determine a task label for each of the plurality of customer-agent interactions;
select a first set of customer-agent interactions from the plurality of customer-agent interactions corresponding to a first task label;
receive application event streams corresponding to the first set of customer-agent interactions and comprising agent application usage data obtained during a customer-agent interaction;
analyze the application event streams for statistically relevant differences for one or more activities performed by a first group of agents of the plurality of agents compared to a second group of agents of the plurality of agents, wherein the first group of agents is identified as higher performing agents compared to the second group of agents based on the ranking of each agent of the plurality of agents;
determine at least one activity of the one or more activities that is performed by the first group of agents differently than the second group of agents;
generate guidance corresponding to the least one activity for the second group of agents; and
deploy the guidance to the second group of agents.

9. The apparatus of claim 8, wherein the first group of agents corresponds to one or more agents of the plurality of agents having a ranking above a first threshold and the second group of agents corresponds to one or more agents of the plurality of agents having a ranking below a second threshold.

10. The apparatus of claim 8, wherein analyzing the application event streams for statistically relevant differences comprises comparing application usage time between the first group of agents and the second group of agents.

11. The apparatus of claim 10, wherein the application usage time between the first group of agents and the second group of agents is different and exceeds an application usage time threshold, generating the guidance comprises coaching on use of an application.

12. The apparatus of claim 8, wherein analyzing the application event streams for statistically relevant differences comprises comparing a sequence of events performed by the first group of agents compared to the second group of agents.

13. The apparatus of claim 12, wherein the sequence of events for the first group of agents is different from the sequence of events for the second group of agents, generating the guidance comprises coaching on a process of handling a task corresponding to the first task label.

14. The apparatus of claim 8, wherein the guidance is deployed to an agent of the second group of agents in near real-time during the customer-agent interaction.

15. A method for providing automated agent performance improvement, comprising:
obtaining a ranking for each agent of a plurality of agents obtaining a plurality of customer-agent interactions and features associated with each of the plurality of customer-agent interactions;
analyzing, per feature, the plurality of customer-agent interactions for statistically relevant differences in behavior by a first group of agents of the plurality of agents compared to a second group of agents of the plurality of agents, wherein the first group of agents is identified as higher performing agents compared to the second group of agents based on the ranking for each of the plurality of agents;
determining at least one feature of the features where the behavior of the first group of agents corresponding to the at least one feature is different than the second group of agents;
generating guidance corresponding to the least one feature for the second group of agents; and
deploying the guidance to the second group of agents.

16. The method of claim 15, further comprising:
receiving application event streams corresponding to the plurality of customer-agent interactions comprising agent application usage data obtained during a customer-agent interaction;
analyzing the application event streams for statistically relevant differences for one or more activities performed by the first group of agents compared to the second group of agents;
determining at least one activity of the one or more activities that is performed by the first group of agents differently than the second group of agents; and
generating guidance corresponding to the least one activity for the second group of agents.

17. The method of claim 15, wherein the first group of agents corresponds to one or more agents of the plurality of agents having a ranking above a first threshold and the second group of agents corresponds to one or more agents of the plurality of agents having a ranking below a second threshold.

18. The method of claim 15, wherein the feature during a customer-agent interaction comprises at least one of:
a time an agent spending talking,
a number of agent interruptions,
a duration of a hold without the agent checking in with a customer,
a time of mutual silence,
use of an application,
a number of knowledge management searches conducted by the agent, or
a usage pattern of a customer relationship management tool.

19. The method of claim 15, wherein the guidance generated comprises at least one of:
a coaching module with respect to talking with a customer,
a coaching module regarding active listening behavior,
a coaching module on how to implement frequent check-ins with the customer, a coaching module with respect to communication skills,
a coaching module on how to use an application,
a coaching module on performing knowledge management searches, or
a coaching module on utilizing a customer relationship management tool for interacting with the customer.

20. The method of claim 15, wherein the guidance is deployed to an agent of the second group of agents in near real-time during a customer-agent interaction.
